(19) United States
(12) Patent Application Publication
(10) Pub. No.: US 2011/0212773 A1
(43) Pub. Date: Sep. 1, 2011

(54) Method and Arrangement for Enabling Games in a Communication Network

(75) Inventors: Johan Hjelm, Tokyo (JP); Olle Eriksson, Stockholm (SE)

(73) Assignee: TELEFONAKTIEBOLAGET LM ERICSSON (PUBL), Stockholm (SE)

(21) Appl. No.: 13/127,610

(22) PCT Filed: Oct. 19, 2009
(86) PCT No.: PCT/SE09/51186

§ 371 Date: May 4, 2011

Related U.S. Application Data
(60) Provisional application No. 61/111,414, filed on Nov. 5, 2008.

(51) Int. Cl. A63F 9/24

(52) U.S. Cl. 463/29

(57) ABSTRACT

A method and apparatus for enabling an electronic game provided by an external game server (202) in a public network (204) and involving multiple players. The players and a plurality of local devices (A,B,C) operated by the players in a local network (200), are registered in a gateway device (GW) connected to the local network. The gateway device then registers the players and devices in the external game server for the electronic game. During the game, the gateway device applies a local game logic and translates any game related messages and/or media communicated between the local devices and the external game server, while communicating with the local devices in the local network using a short-range communication mechanism. As a result, only the gateway device in the local network needs to communicate with the external game server (202) in the public network, which may provide reduced latency in responses to user actions.

### TECHNICAL FIELD

The invention relates generally to a method and arrangement for enabling electronic games involving multiple players in a communication network.

### BACKGROUND

In the field of electronic computer-based games, it has become increasingly popular to employ games involving multiple players in a communication network, each player operating a communication terminal with gaming capabilities. The terminals used may be stationary or portable computers or mobile telephones, and can be either dedicated game consoles or generic communication devices. Such multi-player computer-based games are typically realised by means of a game server situated in a public, or “global”, network and containing a game logic which generally controls the gaming action and its various parameters and functions, depending on the nature of the game. It is also required that each participating player must connect his/her terminal and frequently communicate with the game server during the course of the game in order to transfer various messages, commands, user actions, display data, media content, and so forth, over the public network.

These centrally controlled multi-player games sometimes take huge proportions involving hundreds of players or much more. For example, role-playing games in a computer environment are very popular such as the well-known game called “World of Warcraft” which currently engages around 11 millions of players all over the world.

Another available option is that a pair of user terminals used for playing a two-way computer-based game, communicate directly with each other by means of a peer-to-peer connection, hence without involving a central game server. In this case, the game logic resides locally in the terminals used. In general, a peer-to-peer session does not involve any intermediate network or session controlling node, and the participating parties themselves negotiate and agree on various session parameters to use. During a gaming session, messages and media content are transmitted in data packets between the parties or “peers”, e.g. over different routers in a public IP network such as the Internet. A peer-to-peer gaming session may also be established over a local connection directly between the terminals without any intermediate network nodes at all, e.g. using Bluetooth or other techniques for “short-range” communication.

The scenarios described above are illustrated schematically in FIG. 1 where a set of user terminals A, B and C are used to conduct a computer-based game over a game server 100 situated in a public or global network. The latter may comprise a so-called “IMS (IP Multimedia Subsystem) core” 102 which can be used to generally enable multimedia services and sessions for user terminals connected to different access networks. The game server 100 contains a game logic 100a configured to control the action and different parameters of the game for the participating terminals A-C. The figure also illustrates two user terminals D and E which communicate directly over a peer-to-peer (P2P) connection.

However, there are some drawbacks associated with the solutions outlined above. In the scenario with a game server in a public or global network, it may be a problem that all participating terminals must connect to and communicate with a coordinating game server according to a protocol required by the game server, which some user terminals may not even be capable of doing. Furthermore, communication in a public or global network is generally deemed “unsafe” for the players unless various security functions, such as encryption, are employed by each participating terminal to make the communication sufficiently safe. Considerable network resources and bandwidth are also consumed for this communication.

In this scenario, users may experience considerable latency in response to their actions, depending on the network transfer time and the fact that the user data of the game must be communicated via the game server. Further, the game server must control and cater for different administrative issues such as charging and billing for all individual players, which could be a considerable burden when many players are involved.

Further, many players may desire to interact in the game with each other outside the computer environment, i.e. more or less physically, using physical objects such as cards, boards, checkers, tokens, and so forth. Since all terminals communicate with the game server, it is difficult if not impossible, to bring such physical “off-line” interaction between the players into the game.

In the P2P scenario, all game logic must be available locally in the players' terminals which typically have limited storing and processing capacities. It may neither be desirable to download gaming software to the terminals from an external content server or the like. In either scenario above, it is also difficult to let one terminal control or coordinate the game play for other terminals, such as when a team of players is to be guided or controlled by a teamleader.

### SUMMARY

It is an object of the invention to address at least some of the issues outlined above. It is thus an object to. These objects and others can be achieved primarily by a solution according to the appended independent claims.

According to different aspects, a method and an apparatus are defined for enabling an electronic game provided by an external game server in a public network and involving multiple players.

In the inventive method, a gateway device registers the players and a plurality of local devices operated by the players in at least one local network, the gateway device being connected to the local network(s). The gateway device then registers the players and local devices in the external game server for the electronic game. During the game, the gateway device applies a local game logic in the gateway device and translates any game related messages and/or media communicated between the local devices and the external game server. The gateway device communicates with at least one of the local devices in the local network(s) using a short-range communication mechanism.

An arrangement is also provided in a gateway device configured to perform the method above. According to the inventive arrangement, the gateway device comprises a local registering unit adapted to register the players and a plurality of local devices operated by the players in at least one local network, wherein the gateway device is also connected to the local network(s). The gateway device further comprises an external registering unit adapted to register the players and local devices in the external game server for the electronic game, a game logic unit adapted to apply a local game logic during the game, and a translation unit adapted to translate any game related messages and/or media communicated between the local devices and the external game server during the game.

The inventive method and arrangement above can be used to reduce latency in action response, as well as the communication costs and load in public networks, as compared with previously known solutions. Since the participating players' devices only need to communicate with the gateway device within the local network, it is not necessary to provide for secure communication in the public network for them. Using this solution, multiple players can also physically interact with each other as they interact with an online electronic game more or less in real-time.

The invented method and arrangement above may be implemented according to any of the following optional embodiments.

In one embodiment, the gateway device registers capabilities of the local devices in a capability server in the public network which can be accessed by the external game server when providing the game. The gateway device may also register presence information of the local devices in a presence server in the public network which can be accessed by the external game server when providing the game.

In another possible embodiment, the players are charged for the game by a charging server as triggered by the external game server. The local game logic in the gateway device may comprise commands, rules, and/or parameters which are used to control the game. Further, the gateway device may translate any communicated game related messages and media between one or more protocols used by the local devices and a protocol used by the external game server during the course of the game.

In further possible embodiments, one of the local devices may act as a relay station between at least one of the other local devices and the gateway device. The gateway device may also serve local devices in at least two local networks in which at least one local device acts as a bridge for communication between local devices across the at least two local networks. The gateway device could be operated by a user acting as a master, controller, coordinator, or teamleader for the game.

Further possible features and benefits of the invention will become apparent from the detailed description below.

### BRIEF DESCRIPTION OF THE DRAWINGS

The invention will now be described in more detail by means of exemplary embodiments and with reference to the accompanying drawings, in which:

FIG. 1 is a schematic overview illustrating how electronic games can be provided for multiple players in a communication network, according to the prior art.

FIG. 2 is a schematic overview illustrating how electronic games can be provided for multiple players in a local communication network, when using the invention.

FIG. 3 is a block diagram schematically illustrating functions in a gateway device, according to some possible embodiments.

FIG. 4 is a flow chart illustrating a procedure for enabling an electronic game for players in a local network, according to further possible embodiments.

FIG. 5 is a signalling diagram illustrating in more detail how an electronic game can be enabled in practice for players in a local network, according to a possible communication procedure.

FIG. 6 is a schematic overview illustrating how an electronic game can be conducted with players in two different local networks, according to further possible embodiments.

FIG. 7 is a schematic block diagram illustrating an arrangement in a gateway device in more detail, according to further possible embodiments.

### DETAILED DESCRIPTION

Briefly described, a solution is provided for enabling an electronic game provided by an external game server in a public or global network, where it is not necessary for all players in the game to connect to the game server. Instead, the participating players' devices form a local network that includes a gateway device which handles communication with the game server over the public network on behalf of the devices in the local network. Initially, the players and their devices are registered locally in the gateway device to participate in the game, and the gateway device then registers the players and local devices in the external game server for the electronic game. During the game, the local devices communicate with each other and the gateway device by using a suitable short-range communication mechanism such as, e.g., Bluetooth, Infrared, WLAN (Wireless Local Area Network) or WiFi, when the devices are present in a room or other limited space.

In this description, the term “device” represents any user entity capable of game related communication inside a local network. Further, a public network as described here is the equivalent of a “global” network, while a local network as described here is the equivalent of a “peer” network where local devices are directly connected to one another. Also, a “gateway device” as described here is the equivalent of an “IMS Gateway (IG)” in the case when an IMS core is used. Further, the term “short-range communication mechanism” implies any direct communication between devices present in a room or other limited space.

The various gateway device functions to be described below are implemented in a user device in the local network which may also participate in the game, e.g. operated by a user acting as a master, controller, coordinator, teamleader, etc., for the participating players. The gateway device thus acts as a gateway for the devices in the internal local network towards the game server which is situated in an external public network, e.g. an IMS core. The gateway device may also serve players in more than one local network, which will be described further below.

The gateway device further contains a local game logic with various commands, rules, parameters, and so forth, which are used to conduct and control the game on an local basis. The gateway device also contains a translation function which translates between one or more protocols used by the local devices and a protocol used by the external game server, for any communicated game related commands, messages and media during the course of the game.

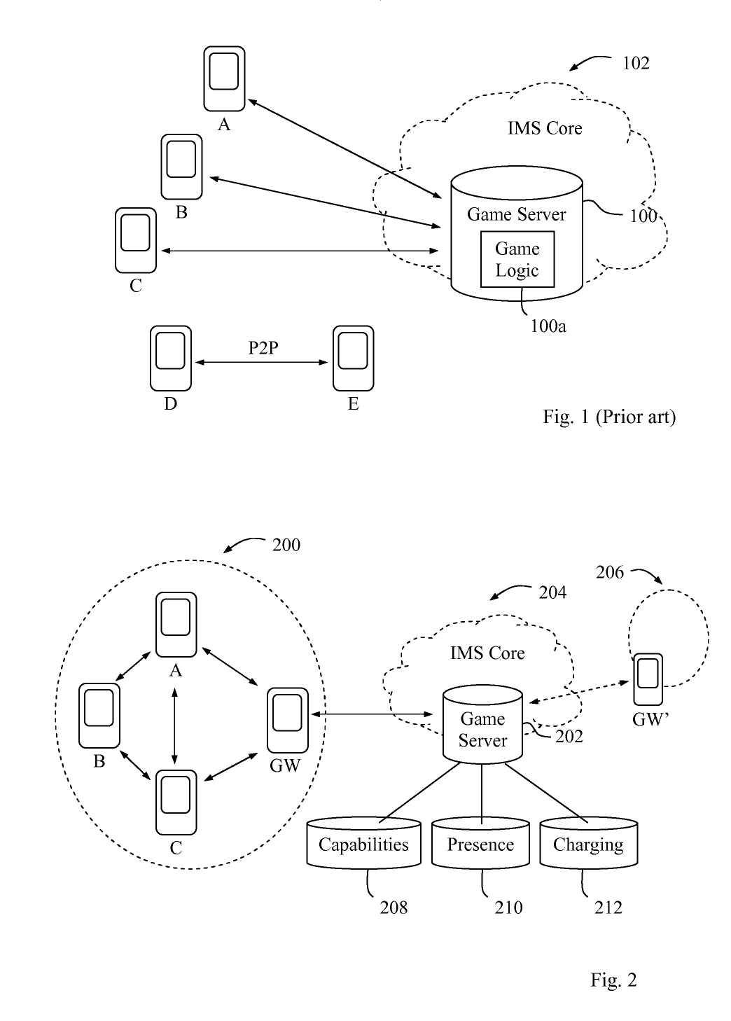

FIG. 2 illustrates an exemplary communication scenario where the invention is used. A local network 200 is formed with a plurality of local devices A, B and C in order to conduct an electronic game provided by an external game server 202 situated in a public network, in this case a multimedia services network comprising an IMS core 204. The game server 202 comprises an external game logic, not shown, as described for FIG. 1 above. In this solution, it is not required that all participating terminals A, B and C are connected to the game server 202 in the public network.

Instead, one local device in the network 200 is used as a gateway device, in the figure denoted “GW”, which is connected to the game server 202 on behalf of the local devices.

Hence, all communications between the local devices and the game server 202 during the course of the game, such as game related messages, commands, user actions, display data and media content, go through the gateway device GW, as indicated by two-way arrows in the figure. The gateway device GW contains a local game logic for handling and controlling the communication of the game. Depending on the nature of the game, the local game logic may comprise functionality for a user that controls the game such as a teamleader, coordinator, or the like, which is however outside the scope of this solution.

As mentioned above, the gateway device also translates between internal and external protocols used by the local devices and the game server, respectively. For example, the local devices A-C may use UPnP (Universal Plug-and-Play) protocols for game communication while the game server 202 may use an IMS protocol, although this solution is not limited to any particular internal and external protocols.

In the local network 200, the local devices A-C communicate with the gateway device GW and each other directly in a peer-to-peer manner using some suitable short-range technique. It is also possible that one of the local devices A and C acts as a relay station between at least one of the other local devices, in this case device B, and the gateway device GW, if that device B is not able to communicate directly with gateway device GW, e.g. when not being within sufficient range for radio contact or similar.

The local network may be an existing WLAN or similar, e.g. connected in a home environment according to Ethernet, or temporarily formed as an “ad hoc” network, e.g. using Bluetooth, Infrared or WiFi. In effect, the local network can thus be considered as a “peer” network and the players and their devices can be considered to constitute a “peer group”.

The players using devices A-C in the local network 200 can easily be present in the same room such that additional physical interaction between the players can also be part of the game, e.g. using physical objects such as cards, boards, checkers, tokens, and so forth, as interactions in the electronic part of the game can be communicated more or less in real-time. This is typically not possible in prior solutions where each player must use a game station connected to an external game server over a public network, which causes considerable latency.

The external game server 202 may also be utilised by further local networks, each using a corresponding gateway device for communication with the game server 202. In the figure, a second local network 206 is shown which is served by a gateway device GW′ for an electronic game in the manner described for network 200. For example, the players in local networks 200 and 206, respectively, may form opposite teams playing towards each other in a shared game as controlled and coordinated by the game server 202, while gateway devices GW and GW′ are operated by respective team leaders or the like.

In this example, the game server 202 is connected to a server 208 in which device capabilities are stored, to be described in more detail further below. The game server 202 is also connected to a presence server 210 which maintains presence information on the players and their devices, and to a charging server 212 responsible for coordinating the charging and billing of the users participating in the game. The users or players may be charged for the game service separately, or for the game service combined with the connection and communication costs.

The gateway device GW may also comprise a presence agent, not shown, which reports device capabilities to the capability server 208, and presence information of the players in the local network 200 to the presence server 210, e.g. when registering the players and their devices for the game. For example, the presence server 210 may keep track of which players are currently online and of how the players are grouped together, when applicable. Alternatively, this type of presence data may be maintained by a separate IMS application server, or by the gateway device GW itself.

When a game is initiated in the local network 200 according to this example, the gateway device GW collects device capabilities and presence information of the participating players/devices, which is then sent to the capability server 208 and the presence server 210, respectively. Thereby, information on device capabilities and the players' presence is readily available in servers 208 and 210 for the external game server when conducting the game, which will be described in more detail further below.

The presence server 210 and the charging server 212 may be referred to as “resource servers” which may be IMS application servers handling the interaction between the players and the IMS operator. The gateway device GW may coordinate the actions of the players in the local network 200 with players in other local networks, e.g. network 206. The gateway device GW may further manage authentication and authorization of the players in network 200 towards the IMS core 204 and towards any other local networks, if applicable. The gateway device

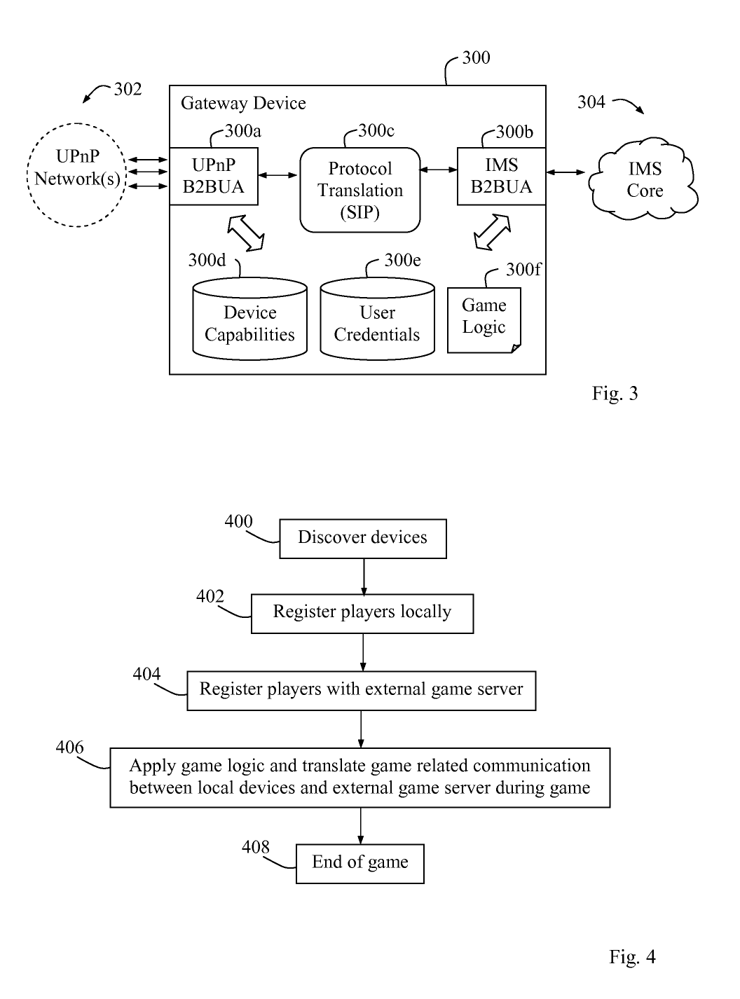

GW may also handle the charging, interaction with the external game logic in game server 202, and any security functions employed for the communication during the game, such as encryption and digital signing. In this respect, it is an advantage that such security functions are only needed for the communication over the public network(s)between gateway device GW and the external game server 202 while the other devices A-C can safely communicate with gateway device GW in a peer-to-peer fashion using short-range links. Some functions in a gateway device that may be employed when using this invention, will now be described with reference to FIG. 3. In the figure, a gateway device 300 serves local devices in a local UPnP network 302, e.g. in a home environment. Generally, UPnP is an architecture with standardised device protocols for a local network with different devices that may use different access technologies, operating systems, programming languages, format standards and communication protocols. UPnP also supports the process called “discovery” in which a device can enter a local network and exchange capabilities and services with other local devices within the network. The gateway device 300 comprises different functions or mechanisms for operating in the manner described herein, e.g. as gateway devices GW and GW′ in FIG. 2. At least some of these functions may be implemented by means of various logic units as shown in FIG. 7, to be described later on below. The gateway device 300 thus basically acts to translate and convey messages and media between local devices in network 302 and an IMS core 304 comprising an external game server, not shown here, and optionally also the servers 208-212 for capabilities, presence and charging described for FIG. 2.

The gateway device 300 comprises a so-called “UPnP B2BUA (Back-to-back User Agent)” 300a acting as a local communication function which communicates internally with each individual local device in network 302 according to their UPnP protocols, during the game. The gateway device 300 further comprises an IMS B2BUA 300b acting as an external communication function which communicates with the game server in IMS core 304 according to a suitable protocol according to IMS, during the game. Between these communication functions 300a and 300b, a translation function 300c is employed which thus translates between the local UPnP protocols and the IMS protocol for any messages and media being conveyed between the local devices and the IMS core. For example, the signalling protocol called “SIP (Session Initiation Protocol)” may be used as an intermediate protocol when translating between the local UPnP protocols and the IMS protocol. In that case, the translation function 300c may be integrated in functions 300a and 300b such that the local communication function 300a also translates from local protocols (e.g. UPnP protocols) to an intermediate protocol (e.g. SIP), and the external communication function 300b also translates from the intermediate protocol to an external protocol (e.g. an IMS protocol) used by the game server.

The gateway device 300 further holds a storage for device capabilities 300d, a storage for user credentials 300e, and a set of rules, definitions and other provisions to be applied when the game is played, which is generally referred to as a game logic 300f. As mentioned above, the players and their devices are registered locally in the gateway device, and then externally in the game server for the electronic game. In the case of using an IMS core, the gateway device has a valid IMS identity, such as an “IMPU” which is a common IMS Public Identity. The local devices may then be registered in the IMS core and game server as “sub-identities” of that IMPU, e.g. IMPU(A), IMPU(B), IMPU(C), and so forth.

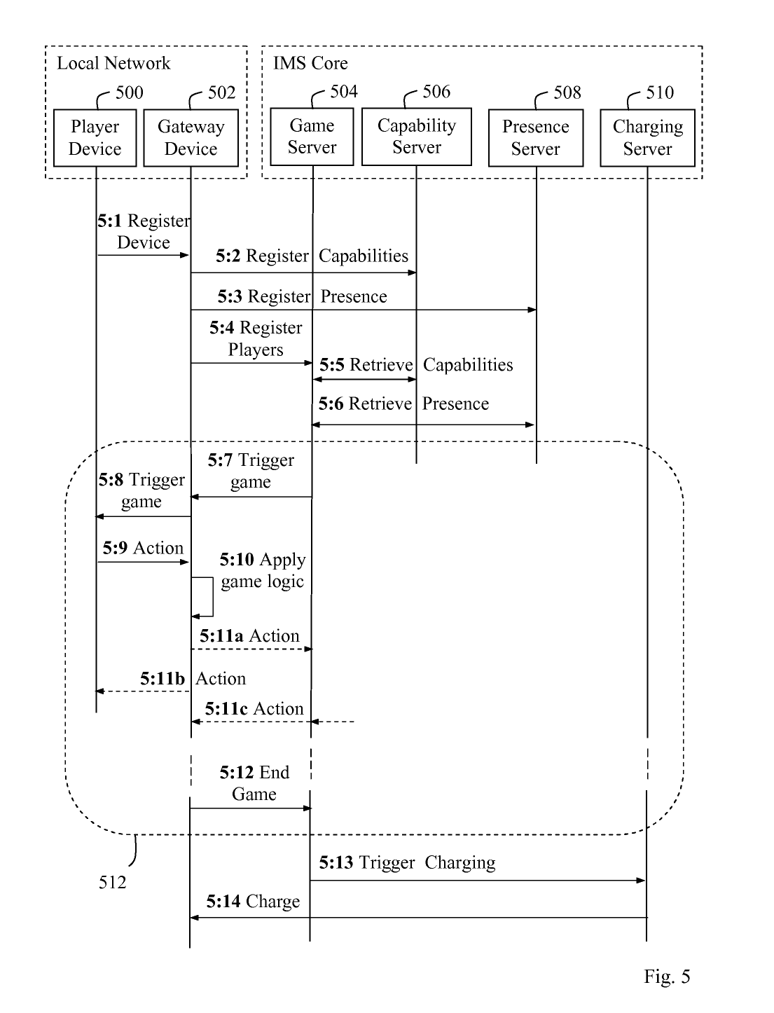

Thus, at some point when the local network 302 is formed or updated, the gateway device 300 obtains device capabilities from the players' devices, e.g. during a discovery process or the like, which is locally stored in the capability storage 300d. Further, registering the players and their devices locally may also include storing of their user credentials in storage 300e to be used for authentication and authorization of the players towards the IMS core 304 and towards any other local networks, if applicable. Then, the players and their devices are registered externally in the IMS core and the external game server for conducting the electronic game, which will be described in more detail later on below with reference to FIG. 5.

A procedure for enabling an electronic game for players in a local network, as executed by a gateway device such as gateway device GW or GW′ in FIG. 2, or gateway device 300 in FIG. 3, will now be described with reference to the flow chart in FIG. 4. A first step 400 illustrates that the players' devices are generally discovered, e.g. when the local network is formed or updated according to an ad hoc or UPnP procedure as described above. In this step, device capabilities and user credentials may be collected in the gateway device as described for FIG. 3 above.

In a next step 402, the players and their devices are registered locally in the gateway device in preparation for playing the electronic game. For example, the user of the gateway device may invite different players to connect to the local network with their devices and to register for participation in the forthcoming game. In this way, a team of players may be formed where the user of the gateway device may act as a teamleader or the like.

In a following step 404, the gateway device registers the players and their local devices externally in an external game server providing the electronic game in a public network. As mentioned above, an IMPU with sub-identities may be used for the external registration in the case of an IMS core. Registering the players and local devices may also include that the gateway device registers capabilities of the local devices in a capability server in the public network which can be accessed by the external game server when providing the game. The gateway device may also register presence information of the local devices in a presence server in the public network which likewise can be accessed by the external game server when providing the game.

Further, the gateway device comprises a local game logic which may involve commands, rules, and/or parameters which are used to control the game for the individual players. According to different options, the gateway device may download this local game logic from the external game server when setting up the game, or it may have been pre-configured in the gateway device at some point earlier, e.g. during configuration of the gateway device.

The local game logic naturally depends on the nature of the game, which is outside the scope of this invention. For example, the local game logic may be configured to apply different conditions and terms for the players during the game, such as presenting different views depending on which role, position or character a player has in the game. One player may be colour-blind and be presented a black-and-white view of the game.

Then, the game is activated or initiated, which may be triggered from the external game server. During the course of the game, the gateway device applies the local game logic and translates any game related messages and/or media communicated between the local devices and the external game server, as shown in a next step 406. In this step, the gateway device communicates with at least one of the local devices in the local network using a short-range communication mechanism. As mentioned above, the game may involve devices in other local networks as well, which is coordinated by the external game server. It is also possible that an individual remote device participates in the game, i.e. without being connected to the local network of the gateway device. In that case, the remote device may communicate with the gateway device, or directly with the game server, over a public network such as a mobile network and/or the Internet, depending on the type and location of the remote device.

In a final shown step 408, the game is eventually finished in the gateway device which may send a suitable message that indicates end of the game to the game server. The game server may then trigger a charging procedure in a charging server such that the players of the game, e.g. as represented by the user of the gateway device, are charged by the charging server. The charging may be triggered by the external game server after the game has been completed or interrupted. Alternatively, the charging may be triggered during the course of the game, e.g. at regular time intervals, at some specific point in the game, when a certain amount of interactions have been made, or when a certain amount of data has been exchanged, and so forth. Furthermore, the charging may be based on the amount of generated traffic or the number of game sessions, etc.

It will now be described in more detail an example of how an electronic game can be enabled in practice for players in a local network, with reference to a series of actions and steps in the signalling diagram in FIG. 5. This procedure involves a local network comprising a plurality of local player devices, of which only one player device 500 is shown here, and a local gateway device 502 which communicates with an IMS core on behalf of the local player devices. The IMS core comprises an external game server 504, a capability server 506, a presence server 508 and a charging server 510. To enable the game, the gateway device 502 has a local game logic and the game server 504 has an external game logic, as described for the previous examples above.

It is assumed that the following procedure described for the local player device 500 is also executed for other player devices in the local network, to provide for multiple players of the game. Further, the gateway device 502 may communicate with the player device 500 and also other player devices in the local network in a peer-to-peer manner and using a short-range communication mechanism. However, some local devices may not be within communication range or unable to communicate with the gateway device 502 for other reasons, and in that case, one or more local devices in the local network may act as relay stations or bridges to convey their communications and actions to/from the gateway device 502.

In a first step 5:1, the device 500 and its user are registered locally with the gateway device 502 to participate as a player in the forthcoming game, as well as other players/devices of the local network. It is assumed that the gateway device 502 has previously obtained information on device capabilities and presence of the users, e.g. during a conventional discovery process or similar mechanism, depending on the type of local network.

Next, the gateway device 502 will register the player and his/her local device externally with the IMS core and the external game server. In a step 5:2, the gateway device 502 thus registers the previously obtained device capabilities in the capability server 506, and also registers the previously obtained presence information in the presence server 508, in a further step 5:3.

In a next step 5:4, the gateway device 502 registers the locally registered players and their devices externally in the game server 504. As mentioned above, an IMPU with sub-identities may be used for the external registration of local devices. The game server then retrieves the device capabilities from the capability server 506 in a step 5:5, and also retrieves the presence information from the presence server 508 in a step 5:6, in preparation for the game.

In this example, after having retrieved the device capabilities and presence information of the other registered players as well, the game server 504 triggers the gateway device 502 to commence the game, in a following step 5:7. This can thus effectively be seen as the first step initiating the course of the game which is indicated in the figure by 512. In this step, game server 504 may communicate the local game logic, or certain game logic related information, to the gateway device 502, if not already installed. For example, game-specific data may be installed in the gateway device 502, e.g. relating to content, rules, functions, etc.

The gateway device 502 then triggers the game to begin in the player device 500, in a following step 5:8, as well as any other local player devices participating in the game. In this step, the gateway device 502 may communicate game rules to the player devices, which may have been received from the game server 504 or set by the user of device 502. The player devices are assumed to have games clients installed for handling the game related communication, e.g. according to the received game rules.

For example, a team captain operating device 502 may decide on limitations and/or enhancements for individual team members, and the gateway device 502 would then communicate this as rules to the player devices, whose games clients then act according to those rules. Different views of the game may be presented according to the rules. The roles or characters in the team can be determined by the rules of the game, so that some users are presented with different views in different ways, e.g. one player may be colour blind while another player can see magical beasts, and so on.

The game rules may be specified by means of a suitable program, e.g. in Java or JavaScript, and may be defined in a rules or policy language and executed by the games clients in the player devices, e.g. RuleML. The rules can also include different charging terms for different players. For example, a player who can see magical beasts may be charged an additional amount. In further examples, players may be charged for the use of virtual objects such as weapons, tools and other useful appliances in the game. Internally within the team, the rules, roles, and use of virtual objects may be coordinated and controlled by the gateway device 502, and externally it may be coordinated and controlled by the external game logic in the game server 504.

At some point, the player device 500 performs an action in the game resulting in an action message to the gateway device 502, in a shown exemplary step 5:9. In response thereto, the gateway device 502 applies the game logic for the received action, in a following step 5:10, which may result in an action message which is translated into the external protocol and sent to the external game server 504, as shown in an exemplary step 5:11a. Alternatively, the game logic in gateway device 502 may trigger an action message directly back to the player device 500, as shown in another exemplary step 5:11b. It is further possible that the game server is triggered by a gateway device in another local network to send an action message to the gateway device 502, as shown in yet another exemplary step 5:11c.

The action messages communicated during the game 512 between player devices and the gateway device 502, and between the gateway device 502 and the game server 504, respectively, may contain various game related messages, commands, user actions, display data and media content, naturally depending on the nature of the game. Any game related messages and/or media communicated between the local devices and the external game server during the game are basically translated at the gateway device 502, i.e. between internal and external protocols used by the local devices and the game server, respectively.

The gateway device 502 also applies the game logic to this type of action messages and in some cases, an action may not be passed on or trigger any other action or message, again depending on the nature of the game. Applying the game logic may involve predicating the interactions between the players towards a scenario which may have been selected by the user of gateway device 502. The predication may depend on the rules of the game, which are expressed in the external game logic in the game server.

In a further step 5:12, the game is finished and an “end-of-game” message or the like is sent from the gateway device 502 to the game server 504. Then, the game server 504 triggers charging for the game in the charging server 510, as shown in a step 5:13. As mentioned above, the charging may be triggered otherwise, e.g. at regular time intervals, at a certain point in the game, when a certain amount of interactions or action messages have been made, or when a certain amount of data has been communicated, and so forth. A logic for ratings may have been provided to the charging server in advance, or may be included with the charging trigger. For example, this ratings logic may include discounts to the players, so that a player may receive a credit amount.

The charging server 510 then forwards applicable charges to the gateway device 502 and its user, as schematically in a step 5:14, who may in turn determine and forward individual chargings to the other players, not shown. Steps 5:7 to 5:12, which constitute the actual game play, may be repeated as needed. The procedure described above may also be executed for one or more other local networks and gateway devices therein, and all these local networks and gateway devices may conduct the electronic game and interact with each other basically in the manner described here.

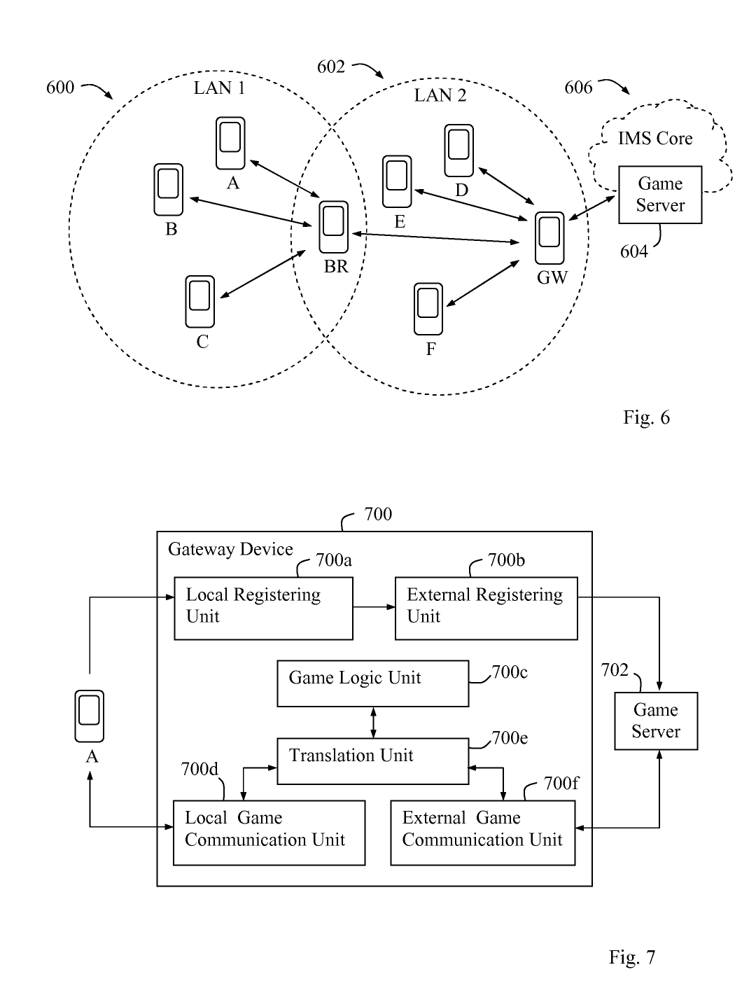

In FIG. 6, an electronic game is conducted with players in two different local networks 600, 602, also denoted LAN 1 and LAN 2 (LAN =Local Area Network). In this example, LAN 2 comprises a gateway device GW that serves the devices in both networks 600, 602 for communication with an external game server in an IMS core 604, basically in the manner described for the above examples in FIGS. 2-5. However, the local networks 600 and 602 use different standards and/or protocols for internal communication such that the devices in LAN 1 cannot communicate with the devices in LAN 2, and vice versa.

In more detail, LAN 1 comprises local devices A, B and C which are not able to communicate with either devices D, E and F, nor with the gateway device GW in LAN 2. Instead, this communication is enabled by means of a particular local device acting as a bridge between the two networks 600, 602, which is denoted “BR” in the figure. Device BR is thus capable of internal communication within both networks 600, 602 and therefore belongs effectively to them both, as illustrated by the dashed overlapping network borders. Thus, any communications between local devices A-C in LAN 1 and gateway device 502 across LAN 1 and LAN 2 goes through local device BR which translates between the two local protocols or standards.

A possible arrangement in a gateway device will now be described in more detail with reference to the block diagram in FIG. 7, which may be used in any of the above-described procedures and embodiments. The gateway device 700 is thus configured to enable an electronic game provided by an external game server 702 in a public network, and involving multiple players in at least one local network.

According to this arrangement, the gateway device 700 comprises a local registering unit 700a adapted to register the players and the local devices operated by the players, of which only one exemplary local device A is shown, wherein the gateway device is also connected to the local network(s). The gateway device 700 further comprises an external registering unit 700b adapted to register the players and local devices in the external game server 702 for the electronic game, and a game logic unit 700c adapted to apply a local game logic during the game. The gateway device 700 also comprises a translation unit 700e adapted to translate any game related messages and/or media communicated between the local devices and the external game server during the game. The gateway device 700 communicates with at least one of the local devices in the local network(s) using a short-range communication mechanism.

The gateway device may further comprise a local game communication unit 700d adapted to communicate messages and/or media internally with the local devices using one or more local device-specific protocols, and an external game communication unit 700f adapted to communicate messages and/or media with the game server using an external protocol used by the game server.

Optionally, the different functional units in the gateway device 700 can be further configured according to the following examples.

In one embodiment, the external registering unit is further adapted to register capabilities of the local devices in a capability server in the public network which can be accessed by the external game server when providing the game. The external registering unit may also be adapted to register presence information of the local devices in a presence server in the public network which can be accessed by the external game server when providing the game.

In further possible embodiments, the local game logic in the game logic unit 700c comprises commands, rules, and/or parameters which are used to control the game. The translation unit 700e may be further adapted to translate any communicated game related messages and media between one or more protocols used by the local devices and a protocol used by the external game server during the course of the game. The gateway device 700 may also serve local devices in at least two local networks in which at least one local device, e.g. device BR in FIG. 6, acts as a bridge for communication between local devices across the at least two local networks.

It should be noted that FIG. 7 merely illustrates various functional units in the gateway device 700 in a logical sense, although the skilled person is free to implement these functions in practice using any suitable software and hardware means. Thus, the invention is generally not limited to the shown structure of the gateway device 700 while its functional units may be configured to operate according to the methods and procedures described above for FIGS. 2-6, where appropriate.

This solution, e.g. according to any of the above-described examples and embodiments, can enable multiple players to physically interact with each other, e.g. using physical objects, as they interact with an online electronic game, and play together in ways which were not possible before, since the game can be coordinated by the gateway device(s) in “real-time” due to reduced response time. For example, a gateway device may also control how the players can interact and perceive the game in a differentiated manner, e.g. depending on the capabilities of their devices and/or their characteristics or roles in the game or team, and so forth. This enables completely new types of gameplay, e.g. involving several teams interacting with each other in different local networks.

Furthermore, latency in action response or the like as well as the communication costs and load in public networks can be reduced. It is neither necessary to provide for secure communication in the public network for all the participating players' devices, since they only need to communicate with the gateway device within the local network.

While the invention has been described with reference to specific exemplary embodiments, the description is generally only intended to illustrate the inventive concept and should not be taken as limiting the scope of the invention. For example, the terms “player device”, “gateway device”, “game server” and “game logic” have been used throughout this description, although any other corresponding functions, nodes and/or units may be used having the functionalities described here. Although the concepts of IMS, UPnP, B2BUA and SIP have been used when describing the above embodiments, any other similar or equivalent standards, protocols and network elements may basically be used as described herein. The invention is defined by the appended claims.

1-16. (canceled)

17. A method implemented by a gateway device connected to at least one local network for enabling an electronic game that is provided by an external game server in a public network and that involves multiple players operating a plurality of local devices in the at least one local network, comprising:
registering said players and local devices with the gateway device,
registering said players and local devices with the external game server, and
applying a local game logic during the electronic game, and
translating any game related messages or media communicated between the local devices and the external game server during the electronic game, communicating with at least one of the local devices in the at least one local network using a short-range communication mechanism.

18. The method according to claim 17, further comprising registering capabilities of the local devices with a capability server in the public network, wherein the capability server can be accessed by the external game server during the electronic game.

19. The method according to claim 17, further comprising registering presence information of the local devices with a presence server in the public network, wherein the presence server can be accessed by the external game server during the electronic game.

20. The method according to claim 17, wherein the players are charged for the game by a charging server as triggered by the external game server.

21. The method according to claim 17, wherein the local game logic in the gateway device comprises at least one of commands, rules, and parameters used to control the electronic game.

22. The method according to claim 17, wherein said translating comprises translating any communicated game related messages and media between one or more protocols used by the local devices and a protocol used by the external game server during the course of the electronic game.

23. The method according to claim 17, wherein one of the local devices acts as a relay station between at least one of the other local devices and the gateway device.

24. The method according to claim 17, wherein the gateway device serves local devices in at least two local networks in which at least one local device acts as a bridge for communication between local devices across the at least two local networks.

25. The method according to claim 17, wherein the gateway device is operated by a user acting as a master, controller, coordinator, or teamleader for the electronic game.

26. A gateway device connected to at least one local network and configured to enable an electronic game that is provided by an external game server in a public network and that involves multiple players operating a plurality of local devices in the at least one local network, comprising:
a local registering unit configured to register said players and local devices with the gateway device,
an external registering unit configured to register said players and local devices with the external game server,
a game logic unit configured to apply a local game logic during the electronic game, and
a translation unit configured to translate any game related messages or media communicated between the local devices and the external game server during the electronic game, wherein the gateway device is configured to communicate with at least one of the local devices in the at least one local network using a short-range communication mechanism.

27. The gateway device according to claim 26, further comprising a local game communication unit configured to communicate at least one of messages and media internally with the local devices using one or more device-specific protocols, and an external game communication unit configured to communicate at least one of messages and media with the game server using an external protocol used by the game server.

28. The gateway device according to claim 26, wherein the external registering unit is further configured to register capabilities of the local devices with a capability server in the public network, wherein the capability server can be accessed by the external game server during the electronic game.

29. The gateway device according to claim 26, wherein the external registering unit is further configured to register presence information of the local devices with a presence server in the public network, wherein the presence server can be accessed by the external game server during the electronic game.

30. The gateway device according to claim 26, wherein the local game logic in the game logic unit comprises at least one of commands, rules, and parameters used to control the game.

31. The gateway device according to claim 26, wherein the translation unit is further configured to translate any communicated game related messages and media between one or more protocols used by the local devices and a protocol used by the external game server during the course of the game.

32. The gateway device according to claim 26, wherein the gateway device is configured to serve local devices in at least two local networks in which at least one local device acts as a bridge for communication between local devices across the at least two local networks.
